(19) United States
(12) Patent Application Publication
(10) Pub. No.: US 2025/0054387 A1
(43) Pub. Date: Feb. 13, 2025

(54) MANAGEMENT SYSTEM

(71) Applicant: TOYOTA JIDOSHA KABUSHIKI KAISHA, Toyota-shi (JP)

(72) Inventors: Shun MARUYAMA, Numazu-shi (JP); Toru TAKASHIMA, Susono-shi (JP); Atsushi TOJO, Susono-shi (JP); Keigo NOGUCHI, Toyota-shi (JP)

(73) Assignee: TOYOTA JIDOSHA KABUSHIKI KAISHA, Toyota-shi (JP)

(21) Appl. No.: 18/633,745

(22) Filed: Apr. 12, 2024

(30) Foreign Application Priority Data
Aug. 10, 2023 (JP) 2023-130882

(51) Int. Cl. G08G 1/09; G01C 21/34; G08G 1/052

(52) U.S. Cl. CPC G08G 1/091; G01C 21/3469; G08G 1/052

(57) ABSTRACT

In this management system, the latest time among the expected arrival times at which each of the plurality of moving objects is expected to reach the destination is set as the reference time. Then, for each of the one or more moving objects other than the moving object predicted to arrive at the destination at the reference time among the plurality of moving objects, the traveling route to the destination and the traveling speed are determined so that the estimated arrival time approaches the reference time and the energy consumption is reduced. Accordingly, it is possible to satisfactorily reduce energy consumption in the entire plurality of moving objects.

### CROSS-REFERENCE TO RELATED APPLICATION

This application claims priority to Japanese Patent Application No. 2023-130882 filed on Aug. 10, 2023, incorporated herein by reference in its entirety.

### BACKGROUND

### 1. Technical Field

The present disclosure relates to a management system that manages movement of a moving object.

### 2. Description of Related Art

Japanese Unexamined Patent Application Publication No. 11-39592 (JP 11-39592 A) describes a traveling state control device that compares a desired arrival time at a destination and an expected arrival time in each of a plurality of vehicles and controls the traveling state of each of the vehicles based on the comparison result. In the traveling state control device, when the expected arrival time is later than the desired arrival time in each of the vehicles, an upper speed limit mode is set and the movement pace is increased. When the expected arrival time is earlier than the desired arrival time, a fuel-saving driving mode is set and the movement pace is reduced.

### SUMMARY

An object of the present disclosure is to satisfactorily reduce energy consumption of a plurality of moving objects.

In a management system according to the present disclosure,
a latest time among expected arrival times at which a plurality of moving objects is expected to arrive at destinations is set as a reference time.

For one or more moving objects except moving objects predicted to arrive at the destinations at the reference time among the plurality of moving objects, a travel route and a travel speed to the destination are determined to bring the expected arrival time closer to the reference time and reduce energy consumption.

Accordingly, it is possible to satisfactorily reduce the overall energy consumption of the moving objects.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing an area in which a plurality of moving objects moves in a management system according to an embodiment of the present disclosure;

FIG. 2 is a diagram conceptually illustrating the plurality of moving objects and a management device included in the management system;

FIG. 3 is a diagram for explaining a method of acquiring an expected arrival time in the management system;

FIG. 4A is a diagram showing an example of a method of determining the above-described travel route, and is a diagram showing an example of a travel route that is tentatively determined;

FIG. 4B is a diagram illustrating an example of a method of determining a travel route, and is a diagram illustrating an example of a travel route determined by bringing an expected arrival time closer to a reference time and reducing energy expenditure; and

FIG. 5 is a flowchart illustrating a travel route and the like determination program stored in the management device of the management system.

### DETAILED DESCRIPTION OF EMBODIMENTS

Hereinafter, a management system according to an embodiment of the present disclosure will be described in detail with reference to the drawings. The management system includes a management device M. The movement of the plurality of moving objects V is managed by the management device M.

### Example 1

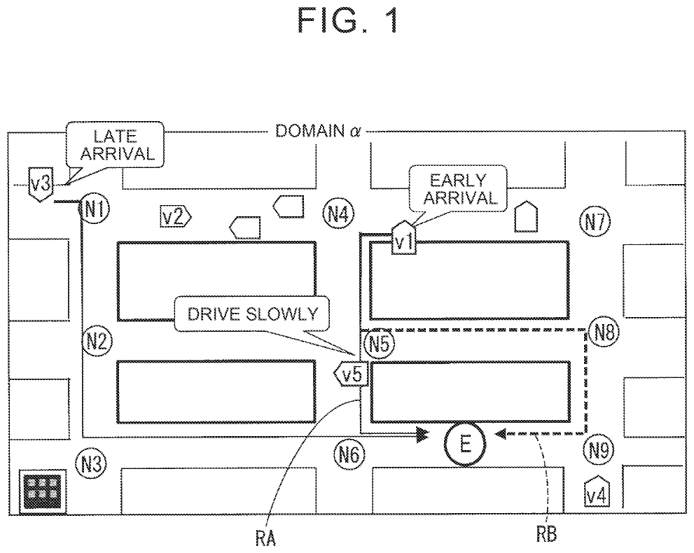

As illustrated in FIG. 1, the region α is a predetermined region. The area α is, for example, a factory and is a private land. Within the region α, it is considered that a general pedestrian other than a known person does not have a general moving object other than a known moving object.

Inside the area α, a plurality of moving objects v (v1,v2,v3.) carry out an operation such as transporting a load. Each of the plurality of moving objects v moves to the destination E. The destination E is set in common to the plurality of moving objects v. At the destination E, the luggage is delivered or the like between the plurality of moving objects v. The plurality of moving objects v usually move toward the next destination after the delivery of the baggage is completed. Therefore, it is desirable that the waiting time at the destination E is shorter in each of the plurality of moving objects v. In addition, in the work, it is desirable that the energy consumption of the plurality of moving objects v is small.

A plurality of passages R are provided inside the region α. Further, a portion where two or more of the plurality of passages R intersect is an intersection N, and the intersection N is referred to as a node N. Inside the area α, there are a plurality of nodes N (node N1,N2,N3.) and the like.

Each of the plurality of moving objects v is, for example, an unmanned travelable Automatic Guided Vehicle v. The plurality of moving objects v move along the passage R inside the region α. The traveling route of each of the plurality of moving objects v usually includes a plurality of nodes N. The plurality of nodes N includes at least one of a corner node in which the moving object v bends and a straight node in which the moving object v travels straight.

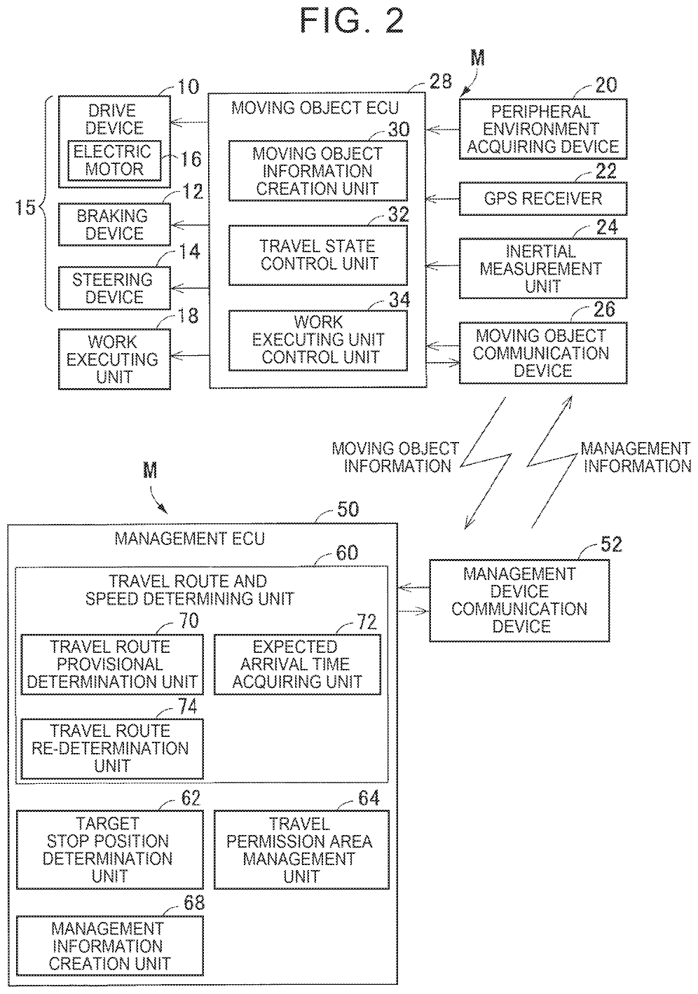

As illustrated in FIG. 2, each of the plurality of moving objects v includes a traveling device 15 including a drive device 10, a braking device 12, a steering device 14, and the like. The drive device 10 includes an electric motor 16. The moving object v is driven by an electric motor 16. The traveling state of the moving object v is controlled by controlling the traveling device 15.

In addition, the moving object v includes a work executing unit 18, a peripheral environment acquiring device 20, a GPS receiver 22, an inertial measurement device 24, a moving object communication device 26, a moving object ECU 28, and the like. The work executing unit 18 includes, for example, one or more arms (not shown), and performs, for example, transfer of a load by an arm or the like. The work executing unit 18 is controlled by the moving object ECU 28 based on a predetermined operation plan.

The peripheral environment acquiring device 20 includes a laser, a camera as an imaging device, and the like. An object or the like located around the moving object v is acquired by the peripheral environment acquiring device 20, and the relative positional relationship between the moving object v and the object is acquired.

Global Positioning System (GPS) Receiver 22 is an exemplary Global Navigation Satellite System (GNSS) receiver. GPS receiver 22 receives and processes GPS. In the present embodiment, the present position of the moving object v is obtained based on GPS received by GPS receiver 22.

The inertial measurement device 24 detects an acceleration or the like as an inertial force acting in each of the front-rear direction, the lateral direction, and the up-down direction of the moving object v. Based on the values detected by the inertial measurement device 24, the traveling speed and the like of the moving object v in the front-rear direction can be acquired.

The moving object communication device 26 is capable of transmitting and receiving information wirelessly. The moving object communication device 26 transmits moving object information and receives management information transmitted from the management device M. The moving object data is created in the moving object ECU 28.

The moving object ECU 28 is mainly composed of a computer. The moving object ECU 28 includes an executing unit, a storage unit, an input/output unit, and the like. A peripheral environment acquiring device 20, a GPS receiver 22, an inertial measurement device 24, a moving object communication device 26, a work executing unit 18, a traveling device 15, and the like are connected to the input/output unit of the moving object ECU 28. Further, the moving object information creation unit 30, the traveling-state control unit 32, the work executing unit control unit 34, and the like included in the moving object ECU 28 include an execution unit, a storage unit, an input/output unit, and the like, respectively.

The moving object information creation unit 30 generates moving object information. The moving object information includes location information, status information, work information, identification information ID, and the like. The position information is information indicating the present position of the moving object v, and is obtained, for example, based on GPS received by GPS receiver 22. The state information includes information indicating a traveling state such as a traveling speed of the moving object v, information indicating a stacking state, and the like. The work information is information indicating the progress status of the work. When the moving object v moves, the progress state can be represented by a current position or the like. The identification-information ID is stored in the storage unit in advance. The moving object information created by the moving object information creation unit 30 is output to the moving object communication device 26 and transmitted.

The traveling state control unit 32 controls the traveling device 15 to control the traveling state of itself (the moving object v). The traveling state control unit 32 controls the traveling device 15 based on a command transmitted from the management device M. The work executing unit control unit 34 controls the work executing unit 18 based on work contents determined by a predetermined work plan.

The management device M includes a management ECU 50 and a management communication device 52.

The management communication device 52 communicates with each of the moving object communication devices 26 of the plurality of moving objects v. The management communication device 52 transmits the management information created in the management ECU 50, and receives the moving object information transmitted by each of the moving object communication devices 26.

The management ECU 50 is mainly a computer. The management ECU 50 includes an executing unit, a storage unit, an input/output unit, and the like. The management communication device 52 is connected to the input/output unit of the management ECU 50. The management ECU 50 includes a travel route and speed determining unit 60, a target stop position determination unit 62, a travel permission area management unit 64, a management information creation unit 68, and the like. The travel route and speed determining unit 60, the target stop position determination unit 62, the travel permission area management unit 64, the management information creation unit 68, and the like include an execution unit, a storage unit, an input/output unit, and the like, respectively.

The target stop position determination unit 62 determines a stop position at the destination E for each of the plurality of moving objects v. The stop position of each of the plurality of moving objects v can be determined to be a position suitable for delivery of a package, for example.

The travel permission area management unit 64 manages a travel permitted area, which is an area permitted to travel, at each of a plurality of nodes (intersections) N inside the area α. There is no traffic light at each node N within region α. Therefore, in each of the nodes N, when there is a possibility that two or more moving objects v enter, traffic arrangement is performed.

For example, in a case where there is a possibility that two or more moving objects v enter the node N, a travel permission area determined according to a predetermined rule is set for each of the two or more moving objects v. Each of the two or more moving objects v passes through the node N in accordance with the set travel permission area. Two or more moving objects v may pass through the node N in order, substantially simultaneously, or the like. In any case, two or more moving objects v can pass through the intersection point (node) N without interfering with each other. Note that each of the two or more moving objects v may be temporarily stopped before the node N. In addition, the travel permission area can be set in order based on, for example, priority.

The travel route and speed determining unit 60 determines, for each of the plurality of moving objects v, a traveling route from the current position to the destination E, a maximum speed and a maximum acceleration in the traveling route, and the like. In this embodiment, the acceleration also includes deceleration. The maximum speed is an allowable maximum speed when traveling on a traveling route, and the maximum acceleration is an allowable maximum acceleration when traveling on a traveling route. Hereinafter, the determined traveling route, the maximum speed, the maximum acceleration, and the like are collectively referred to as a traveling route and the like. The moving object v travels on the traveling route so that the actual traveling speed and acceleration do not exceed the maximum speed and the maximum acceleration. The maximum acceleration refers to an acceleration having a maximum absolute value.

The travel route and speed determining unit 60 includes a travel route provisional determination unit 70, an expected arrival time acquiring unit 72, a travel route re-determination unit 74, and the like.

The travel route provisional determination unit 70 provisionally determines a travel route for each of the plurality of moving objects v. The travel route provisional determination unit 70, for example, can determine a route (hereinafter, may be referred to as a shortest time route) having the shortest time required to travel from the current position to the destination E (hereinafter, referred to as a required time to the destination E) as a travel route. The shortest time path is a path determined according to a predetermined algorithm. The shortest time path is, for example, a path determined by the Dijkstra method or the like.

Further, the maximum speed can be determined as the speed limit of the passage R included in the traveling route. The maximum acceleration is a value determined based on the maximum speed, and is determined to be a larger value when the maximum speed is large than when the maximum speed is small. The maximum acceleration can be determined in consideration of the shape of the shortest time path.

The shortest time path is, for example, a path satisfying one or more of a plurality of conditions including the following (a), (b), and (c).

(a) The number of corner nodes N that each of the plurality of moving objects v passes before arriving at the destination E is small. When the moving object v bends at the corner node N, the moving object v usually decelerates, bends at a constant speed, and then accelerates. Therefore, when the moving object v bends at the corner node N, the time required to the destination E is longer than when traveling through the straight driving node N.

(b) The distance along the travel route from the current position to the destination E (hereinafter, simply referred to as the travel distance) is short. When the travel distance is long, the time required to the destination E is longer than when the traveling distance is short.

(c) It is unlikely that each of the plurality of moving objects v will approach the obstacle. For example, the obstacle often refers to another moving object that performs work inside the region α. If the vehicle approaches an obstacle while traveling on the traveling route, it is necessary to wait until the obstacle leaves the route. Therefore, it takes a long time to reach the destination E.

The method of determining the shortest time path, the maximum speed, and the maximum acceleration in the present embodiment is merely an example, and the method of determining the shortest time path, the maximum speed, and the maximum acceleration are not limited. Similarly, a method of re-determination of a traveling route or the like, which will be described later, may be used.

The expected arrival time acquiring unit 72 acquires an expected arrival time which is a time at which each of the plurality of moving objects v is expected to arrive at the destination E. The estimated arrival time is acquired based on the travel route or the like temporarily determined by the travel route provisional determination unit 70. The estimated arrival time can be acquired based on the current time, which is the current time, and the required time to the destination E. The required time to the destination E can be acquired on the basis of the travel distance K, the maximum speed Vh, the maximum acceleration ah, the turning speed Vw and the required time ts when the corner nodes N travels at a constant speed, and the like.

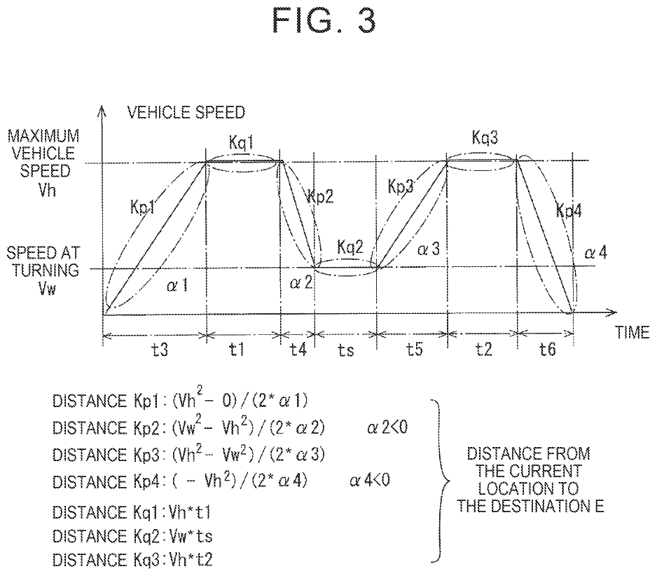

An example of determination of the expected arrival time will be described with reference to FIG. 3.

As shown in FIG. 3, the travel distance K is divided into a distance Kp1,Kp2,Kp3,Kp4 during accelerated traveling and a distance Kq1,Kq2,Kq3 during constant speed traveling. Then, since the sum becomes the travel distance K, the required time to the destination E is acquired. The travel distance K is known.

As shown in the equation below, the distance Kp1 is a distance during the accelerated travel from the current position to the maximum speed Vh. The distance Kp2 is a distance during the deceleration running prior to the corner nodes N. The distance Kp3 is a distance during the accelerated running after turning the corner nodes N. The distance Kp4 is a distance during deceleration running when the vehicle is stopped at the stop position. These can be determined based on the initial speed (0,Vh,Vw,Vh), the final speed (Vh,Vw,Vh,0), the accelerations (α1, α2, α3, α4), and the like. The accelerations α1, α2, α3, and α4 can be set to the maximum acceleration αh.

$$\begin{matrix}Kp 1 = {Vh}^{2} / ( 2 * α1 ) \\ Kp 2 = ( {Vw}^{2} - {Vh}^{2} ) / ( 2 * α2 ) \\ Kp 3 = ( {Vh}^{2} - {Vw}^{2} ) / ( 2 * α3 ) \\ Kp 4 = ( - {Vh}^{2} ) / ( 2 * α4 )\end{matrix}$$

The distance Kq1, Kq3 during constant speed traveling is the distance during constant speed traveling at the limited speed, and the distance Kq2 is the distance during constant speed traveling at the time of turning. The distance may be obtained based on the travel speed and time.

$$\begin{matrix}Kq 1 = Vh * t 1 \\ Kq 2 = Vw * ts \\ Kq 3 = Vh * t 2 \\ K = \sum Kpi + \sum Kqj\end{matrix}$$

From the above equation, the sum of the temporal t1, t2 can be obtained. On the other hand, the temporal t3, t4, t5, t6 during the acceleration travel can be obtained according to the following equation based on the final speed, the initial speed, and the acceleration described above.

$$\begin{matrix}t 3 = Vh / α1 \\ t 4 = ( Vw - Vh ) / α2 \\ t 5 = ( Vh - Vw ) / α3 \\ t 6 = - Vh / α4\end{matrix}$$

From the above, the time-required te to the destination E can be obtained according to the following equation. Further, the estimated arrival time Ta can be acquired based on the present time and the required time te to the destination E.

te=Σti+ts

The travel route re-determination unit 74 compares the estimated arrival time Ta of each of the plurality of moving objects v, and determines the latest time as the reference time Tb. Then, for the moving object v with the latest expected arrival time Ta, the traveling route and the like determined by the travel route provisional determination unit 70, such as the traveling route, are re-determined as the traveling route and the like of the moving object v.

Further, for each of the one or more moving objects v whose expected arrival time Ta is earlier than the reference time Tb among the plurality of moving objects v, the travel route and the like are determined again so that the estimated arrival time Ta approaches the reference time Tb and the power consumed as the consumed energy is reduced. One or more of the traveling route, the maximum speed, the maximum acceleration, and the like determined by the travel route provisional determination unit 70 such as the traveling route are changed and determined again to the changed traveling route, the maximum speed, the maximum acceleration, and the like.

In the present embodiment, the traveling route, the maximum speed, the maximum acceleration, and the like are determined so that the power consumed is the lowest within a range in which the expected arrival time Ta is not slower than the reference time Tb. In addition, when the drive device 10 includes the electric motor 16, the lower the traveling speed, the lower the power consumption as the energy consumption. Further, the number of times of acceleration and deceleration is small, and as the maximum acceleration is small, the power consumption decreases.

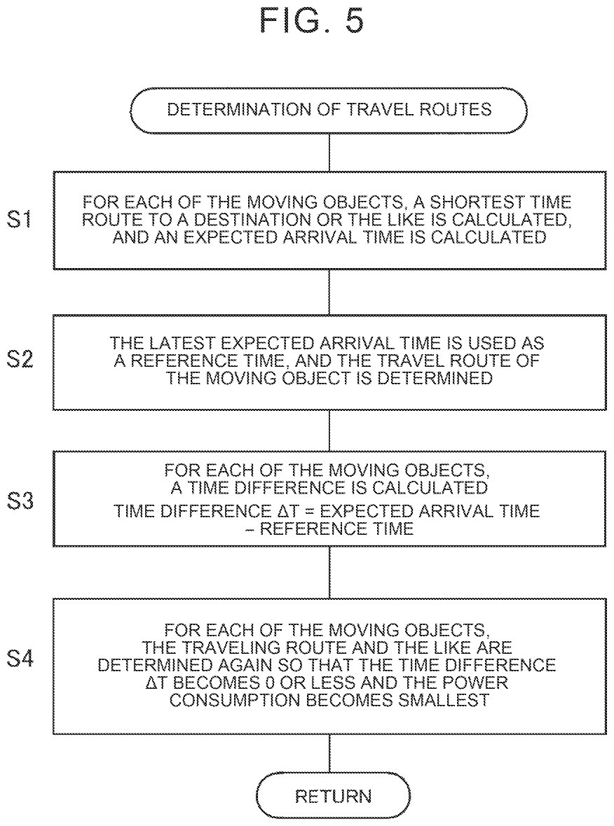

In the management system configured as described above, in the management device M, a travel route and the like determination program represented by the flowchart of FIG. 5 are executed. The travel route and the like determination program is executed before the departure of the plurality of moving objects v.

Step 1 (hereinafter, abbreviated as S1). In other steps, the travel route provisional determination unit 70 provisionally determines the shortest time route and the like to the destination E for each of the plurality of moving objects v. Further, the expected arrival time acquiring unit 72 acquires the expected arrival time Ta for each of the plurality of moving objects v on the basis of the shortest time path or the like.

In S2, the latest time among the estimated arrival time Ta for each of the plurality of moving objects v is set as the reference time Tb, and the shortest time route and the like for the moving object (v3) are determined again as the traveling route and the like. In S3, for each of the one or more moving objects v1,v2,v4. excluding the moving object v3 from the plurality of moving objects v, a time difference ΔT between the respective expected arrival time Ta and the reference time Tb is obtained. In other words, the time difference ΔT is obtained for each of the one or more moving objects v1,v2,v4. in which the estimated arrival time Ta is earlier than the reference time Tb among the plurality of moving objects v.

In S4, the travel route and the like are determined again by the travel route re-determination unit 74 so that the time-difference ΔT is 0 or less and the power consumed is the smallest for each of the one or more moving objects v. The shortest time path or the like is changed and determined.

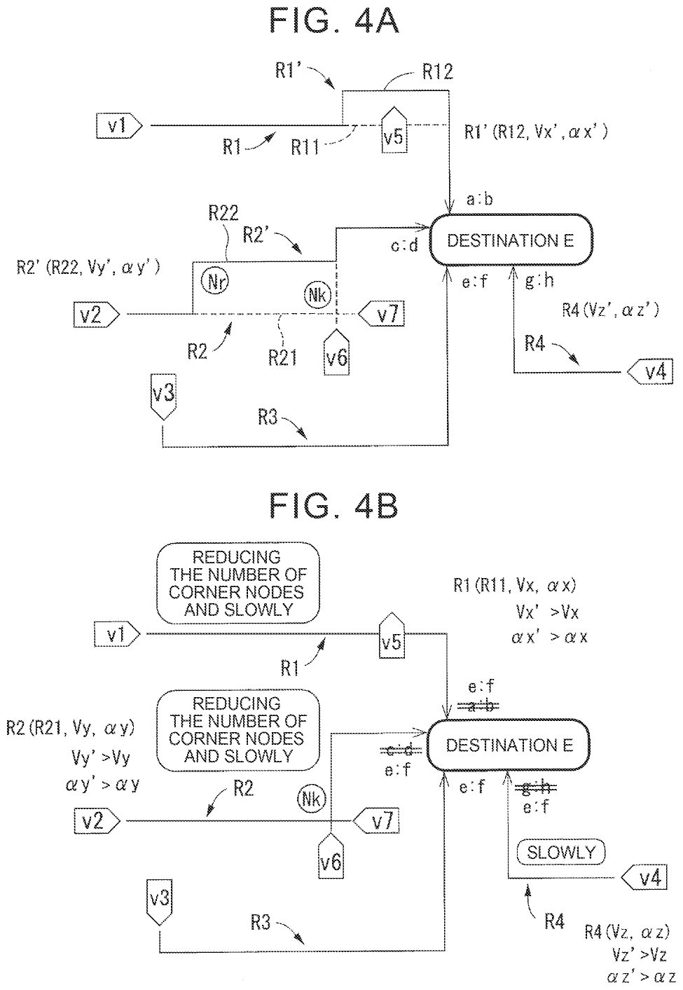

FIGS. 4A and 4B illustrate an exemplary determination of a traveling route and the like. FIG. 4A shows an exemplary case where the travel route or the like is provisionally determined to be the shortest time-distance. FIG. 4B shows an exemplary case where the travel route and the like are determined again.

In FIG. 4A, it is assumed that the moving object v1 travels along the route R1 from the current position to the destination E. On the partial R11 of the route R1, a moving object v5 (which is an exemplary obstacle) is stopped and is performing an operation. The moving object v1 is likely to approach the moving object v5 when traveling along the route R1. Therefore, the moving object v1 needs to be paused in front of the obstacle v5, and it takes a long time to reach the destination E.

In contrast, there is no obstacle such as a moving object v5 in the detour R12 that bypasses the partial R11. Therefore, when passing through the detour R12, te required to the destination E is shorter than when passing through the partial R11. Therefore, in the present embodiment, the route R1′ passing through the detour R12 is set as the shortest-time path of the moving object v1. However, the route R1′ including the detour R12 consumes more power due to a larger number of corner nodes, a longer travel distance, and the like as compared with the route R1.

For example, in FIG. 1, it can be considered that, with respect to the moving object v1, the route RA that reaches the destination E via the nose N4,N5,N6 corresponds to the route R1, and the route RB that reaches the destination E via the nose N4,N5,N8,N9 corresponds to the route R1′.

Further, in FIG. 4A, a route R2 is assumed for the moving object v2. However, in an intersection (corner nodes) Nk included in the partial R21 of the route R2, it is highly likely that another moving object v6, v7 enters the intersection Nk at approximately the same time as the moving object v2. Therefore, the moving object v2 may be temporarily stopped in front of the intersection Nk for a long time.

On the other hand, in an intersection (conner nods) Nr included in the detour R22 that bypasses the partial R21, it is unlikely that the other moving object v will enter the intersection Nr at approximately the same time. Therefore, it is considered that the route R2′ passing through the detour R22 has a larger number of corner nodes and consumes more power than the route R2 including the partial R21, but te of times required to the destination E is shorter. Therefore, in the present embodiment, the route R2′ is set as the shortest-time path.

For the moving object v3 and the moving object v4, the route R3,R4 in which the travel distance from the current position to the destination E is the shortest is set as the shortest-time route.

Then, the estimated arrival times at which each of the moving object v1,v2,v3,v4 is expected to arrive at the destination E when traveling to the destination E along the shortest time route R1′, R2′, R3, R4 are respectively acquired as described above. The latest time among the estimated arrival times of each of the moving object v1,v2,v3,v4 is set as the reference time. When the estimated arrival time e:f of the moving object v3 is the latest, the estimated arrival time e:f is set as the reference time. Then, for each of the moving object v1,v2,v4 that arrives at the destination E prior to the reference time e:f, at least a part of the provisionally determined traveling route or the like is changed, and the traveling route or the like is determined again.

As shown in FIG. 4B, the traveling route of the moving object v1 is changed from the route R1′ to the route R1. The route R1 has a shorter travel length and fewer corner nodes N than the route R1′. In addition, the maximum speed and the maximum acceleration can be changed to a value smaller than the maximum speed and the maximum acceleration determined by the travel route provisional determination unit 70. Therefore, even when the moving object v1 approaches the moving object v5 and is temporarily stopped in the partial R11, it is possible to reduce the power consumption and bring the estimated arrival time close to the reference time e:f as compared with the case where the moving object travels in the route R1′.

In addition, when the maximum speed and the maximum acceleration are determined to be such that the moving object v1 approaches the partial R11 after the moving object v5 leaves, the moving object v1 does not need to be stopped once. Therefore, it is possible to further reduce power consumption.

The same applies to the moving object V2, and the traveling route for the moving object V2 is changed from the route R2′ to the route R2 and determined. Even when the moving object v2 is stopped in front of the corner nodes Nk, the power consumed by the moving object v2 can be reduced by reducing the maximum speed and the maximum acceleration, and the expected arrival time can be brought close to the reference time.

In addition, when the maximum speed and the maximum acceleration are determined to be such that the moving object v2 approaches the corner nodes Nk after the other moving object v6, v7 passes through the corner nodes Nk, the power dissipation can be further reduced.

For the moving object V4, the traveling route R4 is not changed, but the maximum speed and the maximum acceleration are changed to a value smaller than the value determined by the travel route provisional determination unit 70. The maximum speed and the maximum acceleration can be determined to be small so as to approach the reference time Tb within a range in which the estimated arrival time Ta for the moving object v4 is not slower than the reference time Tb. Thereby, the power consumption can be reduced satisfactorily.

The traveling of the plurality of moving objects v is managed based on the traveling route and the like determined as described above. In the management device M, the position of each of the plurality of moving objects v is acquired based on the moving object information. Then, management information including a traveling route or the like determined based on the positions of the plurality of moving objects v and the traveling route or the like determined by the travel route and speed determining unit 60 is created and transmitted. Each of the moving objects v controls the traveling device 15 based on the traveling route and the like included in the management information, and travels along the traveling route.

In addition, in the management device M, when it is determined that the travel route or the like needs to be changed from the position of the moving object acquired based on the moving object information, the travel route or the like is changed as appropriate, and management information including the changed travel route or the like is created and transmitted.

As described above, in the present embodiment, the travel route and the like of each of the plurality of moving objects v are determined such that the estimated arrival time Ta approaches the reference time Tb and the power consumed is the lowest. Therefore, in the case of moving to the destination, it is possible to satisfactorily reduce the power consumption of the plurality of moving objects v. Further, since the reference time Tb is the latest time among the estimated arrival times of each of the plurality of moving objects v, the estimated arrival time Ta of each of the one or more moving objects v can be made close to the reference time Tb satisfactorily, so that the power consumed can be reduced satisfactorily.

On the other hand, in the management system described in JP 11-39592 A, since the moving pace of the moving object whose expected arrival time is earlier than the desired arrival time is delayed, it is possible to reduce the energy consumption. However, since the moving pace of the moving object after the expected arrival time is the desired arrival time is increased, it may be difficult to reduce the energy consumption. From the above, in the management system according to the present embodiment, it is possible to achieve better reduction in energy consumption than in the management system described in JP 11-39592 A.

In the management system described in JP 11-39592 A, as described in paragraph [0026], the travel route provisional determination unit provisionally determines the travel route or the like of each of the plurality of moving objects so that the expected arrival time approaches the desired arrival time. The estimated arrival time is acquired based on the provisionally determined travel route or the like. Therefore, for a moving object whose expected arrival time is later than the desired arrival time, it may be difficult to accelerate the expected arrival time by increasing the moving pace depending on a speed limit or the like set in advance on the traveling route.

On the other hand, in the present embodiment, the estimated arrival time Ta is acquired based on the shortest time path or the like, and the latest time among the estimated arrival time Ta acquired for each of the plurality of moving objects v is set as the reference time Tb. Therefore, all of the plurality of moving objects v can arrive at the destination E by the reference time Tb. In other words, the reference time Tb can be determined at the earliest time at which all the plurality of moving objects v can arrive at the destination E. Accordingly, it is possible to improve the work efficiency while shortening the waiting time of each of the plurality of moving objects v.

In the present embodiment, the part of the management ECU 50 that stores the travel route and the like determination program represented by the flow chart of FIG. 5, the part to be executed, and the like constitute a travel route and speed determining unit, and the part to be executed, the part to execute S1, the part to be stored, and the like constitute a provisional travel route and speed determining unit, and the expected arrival time acquiring unit.

It is not essential that both the travel route and the maximum speed be determined by changing the travel route re-determination unit 74, and it is also possible to change either one of the travel route and the maximum speed without changing the other.

Further, in the above embodiment, the maximum speed and the maximum acceleration are determined to be the minimum value within a range in which the expected arrival time is not later than the reference time, but the time difference ΔT obtained by subtracting the reference time from the expected arrival time may be determined to be the minimum value in a range smaller than a predetermined positive set value. The moving object v1,v2,v4 may arrive somewhat later than the moving object v3.

Further, in the above-described embodiment, the travel route and the like are re-determined based on the expected arrival time, the reference time, and the like, but the travel route and the like can be re-determined so that the required time to the destination E approaches the reference time and the power consumption is reduced for each of the one or more moving objects v whose required time to the destination E is shorter than the reference time with the longest required time to the destination E as the reference time.

The disclosure can also be carried out in various other forms in which various changes and improvements are made based on knowledge of a person skilled in the art.

(1) A management system for managing movement of a plurality of moving objects,

For each of the plurality of moving objects, an expected arrival time at which the moving object is expected to reach the destination is acquired, and the latest time among these is set as a reference time,
A management system, comprising: a travel route and speed determining unit that determines a traveling route to the destination and a traveling speed so that the expected arrival time approaches the reference time and consumes less energy for each of one or more moving objects whose expected arrival time is before the reference time among the plurality of moving objects.

(2) A management system for managing movement of a plurality of moving objects,

For each of the plurality of moving objects, the travel route to the destination and the travel speed are tentatively determined,
On the basis of the provisionally determined travel route and the travel speed, each of the plurality of moving objects is expected to reach the destination.
The latest time among the estimated arrival times acquired for each of the plurality of moving objects is set as a reference time,
The management system includes a travel route and speed determining unit that changes at least one of the provisionally determined travel route and the travel speed so that the expected arrival time approaches the reference time and the energy consumption is reduced for each of one or more moving objects whose expected arrival time is before the reference time among the plurality of moving objects, and determines the travel route and the travel speed again.

In many cases, the current positions of the plurality of moving objects are different from each other. In addition, the plurality of moving objects depart from the current position at substantially the same time (substantially simultaneously).

The estimated arrival time of each of the plurality of moving objects to the destination is acquired based on the current time and the time required to travel from the current position to the destination (time required to the destination). Therefore, the acquisition of the estimated arrival time is intended to include the acquisition of the required time to the destination. In addition, the fact that the expected arrival time is fast corresponds to the fact that the required time to the destination is short.

(3) The management system according to (1) or (2), wherein the travel route and speed determining unit determines the traveling speed to be a maximum speed that is a maximum speed permitted in the traveling route.

(4) The management system according to any one of (1) to (3), wherein the travel route and speed determining unit determines a maximum acceleration which is a maximum acceleration permitted when each of the plurality of moving objects travels along the travel route based on at least one of the travel route and the travel speed.

(5) For each of the plurality of moving objects, the travel route and the travel speed are determined by the travel route and speed determining unit so that a required time, which is a time required for traveling to the destination, is shortest, for each of the plurality of moving objects. The management system according to any one of (1) to (4), further comprising an expected arrival time acquiring unit that acquires an expected arrival time at which the moving object is expected to reach the destination for each of the plurality of moving objects based on the temporarily determined travel route and the travel speed.

(6) The management system according to (5), wherein the expected arrival time acquiring unit includes a provisional travel route and speed determining unit that temporarily determines the travel route and the travel speed on the basis of one or more of a number of corner nodes to the destination, a possibility of approaching an obstacle, and a travel distance that is a distance along the travel route between the current position and the destination.

The technical features described in this section can be applied to, for example, a case where a travel route or the like is re-determined.

(7) The travel route and speed determining unit temporarily determines a traveling route and a traveling speed to the destination for each of the plurality of moving objects,

Based on the provisionally determined travel path and the travel speed, for each of the plurality of moving objects, to obtain the expected arrival time,
For each of one or more moving objects whose expected arrival time is before the reference time among the plurality of moving objects, the estimated arrival time is not later than the reference time. The management system according to any one of (1) to (6), wherein at least one of the temporarily determined travel route and the travel speed is changed so that the energy consumption is minimized within a range in which the expected arrival time is not slower than the reference time, and the travel route and the travel speed are determined again.

(8) The travel route and speed determining unit temporarily determines a traveling route and a traveling speed to the destination for each of the plurality of moving objects,

Based on the provisionally determined travel path and the travel speed, for each of the plurality of moving objects, to obtain the expected arrival time,
For each of one or more moving objects whose expected arrival time is before the reference time among the plurality of moving objects, a time difference which is a value obtained by subtracting the reference time from the expected arrival time is equal to or less than a positive set value. The management system according to any one of (1) to (7), wherein at least one of the provisionally determined travel route and the travel speed is changed so that energy consumption is minimized.

There may be a moving object arriving at the destination somewhat later than the reference time.

(9) The management system according to any one of (1) to (8), wherein the travel route and speed determining unit determines the traveling route for each of the plurality of moving objects before departure of the plurality of moving objects.

(10) The management system according to any one of (1) to (9), wherein each of the plurality of moving objects includes a driving device that consumes less energy as the traveling speed becomes slower.

Each of the moving objects is an electric moving object and includes a driving device including an electric motor.

(11) A management system for managing movement of a plurality of moving objects includes
the travel route and speed determining unit for determining the traveling path and the traveling speed of each of the plurality of moving objects.
   The travel route and speed determining unit includes,
for each of the plurality of moving objects, a travel route and the like provisional determining unit for provisionally determining the travel route and the travel speed to the destination, respectively,
an expected arrival time acquiring unit that acquires an expected arrival time at which each of the plurality of moving objects is expected to reach the destination, based on the traveling route and the traveling speed for each of the plurality of moving objects determined by the provisional determination unit such as the traveling route, and
a travel route redetermination unit that redetermines the traveling route and the traveling speed by changing at least one of the traveling route and the traveling speed determined by the provisional determination unit so that each of the expected arrival times approaches the reference time and the energy consumption is reduced for each of one or more moving objects whose expected arrival time is before the reference time among the plurality of moving objects by setting the latest time among the plurality of expected arrival times acquired by the expected arrival time acquiring unit as a reference time.

The management system described in this section can employ the technical features described in any of paragraphs (1) to (10).

What is claimed is:

1. A management system configured to manage movement of a plurality of moving objects, the management system comprising a travel route and speed determining unit configured to:
acquire, for each of the moving objects, expected arrival times at which the moving objects are expected to arrive at destinations, and set a latest time among the expected arrival times as a reference time; and
determine, for one or more moving objects in which the expected arrival time is earlier than the reference time among the plurality of moving objects, a travel route and a travel speed to the destination to bring the expected arrival time closer to the reference time and reduce energy consumption.

2. The management system according to claim 1, wherein the travel route and speed determining unit is configured to determine the travel speed to be a maximum speed permitted in the travel route.

3. The management system according to claim 1, wherein:
the travel route and speed determining unit is configured to tentatively determine, for each of the moving objects, the travel route and the travel speed to the destination to minimize a required period for traveling to the destination; and
the travel route and speed determining unit includes an expected arrival time acquiring unit configured to acquire, for each of the moving objects, the expected arrival time at which the moving object is expected to arrive at the destination based on the travel route and the travel speed determined tentatively.

4. The management system according to claim 1, wherein the travel route and speed determining unit is configured to:
tentatively determine the travel route and the travel speed to the destination for each of the moving objects;
acquire the expected arrival time for each of the moving objects based on the travel route and the travel speed determined tentatively; and
redetermine, for one or more moving objects in which the expected arrival time is earlier than the reference time among the plurality of moving objects, the travel route and the travel speed by changing at least one of the travel route and the travel speed determined tentatively to minimize the energy consumption within a range in which the expected arrival time is not later than the reference time.
